(19) United States
(12) Patent Application Publication
(10) Pub. No.: US 2013/0145093 A1
(43) Pub. Date: Jun. 6, 2013

(54) NON-VOLATILE SEMICONDUCTOR MEMORY AND DATA READING METHOD THEREOF

(71) Applicants: Takehiro Kaminaga, Tokyo (JP); Masaru Yano, Tokyo (JP)

(72) Inventors: Takehiro Kaminaga, Tokyo (JP); Masaru Yano, Tokyo (JP)

(73) Assignee: WINBOND ELECTRONICS CORP., Taichung City (TW)

(21) Appl. No.: 13/553,783

(22) Filed: Jul. 19, 2012

(30) Foreign Application Priority Data
Dec. 5, 2011 (JP) 2011-265394

(51) Int. Cl. G06F 12/00

(52) U.S. Cl. 711/114; 711/E12.001

(57) ABSTRACT

A non-volatile semiconductor memory is provided, including a memory array having a first and a second memory planes, a page buffer, holding data transmitted by pages selected by address information from a memory array; data register, capable of serially outputting data received by the page buffer according to a clock signal. The pages selected by the first and the second memory planes are simultaneously transmitted to the page buffer. The data reading includes: transmitting the data of the second page of the second memory plane from the page buffer to the data register when the data of the first page of the first memory plane is outputted from the data register; transmitting the data of the second page of the first memory plane from the page buffer to the data register when the data of the second page of the second memory plane is outputted from the data register.

### CROSS-REFERENCE TO RELATED APPLICATION

This application claims the priority benefit of Japan application serial no. 2011-265394, filed on Dec. 5, 2011. The entirety of the above-mentioned patent application is hereby incorporated by reference herein and made a part of this specification.

### BACKGROUND OF THE INVENTION

1. Field of the Invention

The invention generally relates to a non-volatile semiconductor memory and a data reading method thereof, and more particularly, to a method for reading a NAND flash memory.

2. Description of Related Art

A typical NAND flash memory includes a memory array that is formed by arranging a plurality of NAND strings along the row and the column directions. Each NAND string includes a plurality of serially connected memory cells and a bit line selection transistor (BST) and a source line selection transistor (SST) connected to both ends of the NAND string. FIG. 12 is a circuit diagram illustrating the structure of NAND strings in a memory block. In the memory block, a plurality of NAND strings (referred to as cell units NU thereinafter), each of which is formed by serially connecting a plurality of memory cells, is formed along the column and row directions. In FIG. 12, a cell unit NU is composed of 32 serially connected memory cells MCi (i=0, 1, . . . , 31) and a BST and an SST connected to both ends of the cell unit NU. The drain of the bit line selection transistor BST is connected to a corresponding bit line GBL, and the source of the source line selection transistor SST is connected to a common source line SL. The control gate of the memory cell MCi is connected to a word line WLi. The gates of the bit line selection transistor BST and the source line selection transistor SST are respectively connected to the selection gate lines SGD and SGS, and the selection gate lines SGD and SGS are extended in parallel with the word lines WLi.

Generally speaking, each memory cell has a metal-oxide-semiconductor (MOS) structure. The MOS structure includes source/drain of N-type diffusion region, a tunnel oxide layer formed on a channel between the source and the drain, a floating gate (charge storage layer) formed on the tunnel oxide layer, and a control gate formed over the floating gate with a dielectric layer in between. When no charge is stored in the floating gate (i.e., when data “1” is written), the threshold is negative and the memory cell is normally on. When electrons are stored in the floating gate (i.e., when data “0” is written), the threshold is positive and the memory cell is normally off.

In a reading operation, a low-level voltage (L level, for example, 0 V) is supplied to the control gate of the selected memory cell and a high-level voltage (H level, for example, 4.5 V) is supplied to the control gates of those unselected memory cells, so as to turn on the bit line selection transistor and the source line selection transistor and detect the voltage level on the bit line. In a programming (i.e., writing) operation, a voltage of 0 V is supplied to the P-well of the substrate, the drain, the channel, and the source of the memory cell, a H level programming voltage Vpgm (for example, 20 V) is supplied to the control gate of the selected memory cell, and an intermediate-level voltage (for example, 10 V) is supplied to the control gates of those unselected memory cells, so as to turn on the bit line selection transistor and turn off the source line selection transistor. Besides, a voltage is supplied to the bit lines according to the data “0” or “1”, so as to write the data. In an erasing operation, a voltage of 0 V is supplied to the control gate of the selected memory cell in the memory block, a H level voltage (for example, 20 V) is supplied to the P-well, and electrons in the floating gate are extracted to the substrate, so as to erase data in unit of block.

In a NAND flash memory, a page buffer is used in order to read data from or write data into the memory array. While reading data, data in the selected pages of the memory array is transmitted in parallel to the page buffer via the bit lines, and data stored in the page buffer is sequentially output according to a clock signal. While writing data, data is sequentially input into the page buffer according to a clock signal, and after that, the data is written from the page buffer into the selected pages of the memory array via the bit lines. A NAND flash memory is disclosed in the patent documentation 1. An address information is input, and a page is selected according to the address information. When data in the selected page is transmitted from the memory array to the page buffer, a busy signal is output to prohibit any external access. After the data transmission is completed, a ready signal is output to allow external access. Additionally, a semiconductor memory is disclosed in the patent documentation 2. The semiconductor memory is synchronized with a clock signal so that high-speed burst read can be performed.
[Patent Documentation 1] Japanese Application Publication No. JP 2002-93179.
[Patent Documentation 2] Japanese Application Publication No. JP 2010-9646.

As disclosed in the patent documentation 1, when a conventional NAND flash memory is read, a period tR (i.e., a busy period) for transmitting data from the memory array to the page buffer in response to the input of an address information is much longer than a reading period tRC for reading data from the page buffer. Thus, when a plurality of discontinuous pages is burst read, a busy period is produced every time when the address information for selecting a page is input and data is transmitted from the memory array to the page buffer. Accordingly, the burst read operation is very time-consuming. In addition, because a NAND flash memory may have invalid blocks that cannot be normally accessed, it may be impossible to sequentially move from a specific memory block to a next memory block to burst read the pages. Namely, invalid blocks have to be skipped to read data, and address information for selecting the first page of each invalid block has to be input.

Moreover, a cache register is used in the conventional NAND flash memory. Data in a next output page is moved into the page buffer at the same time during data in the cache register being serially output. Such cache read is to transmit data of a next page from the page buffer to the cache register after data of all pages in the cache register is read, and no data is output from the cache register during the data transmission period. In other words, discontinuous blank periods may be produced when a plurality of pages is burst read in a burst mode.

### SUMMARY OF THE INVENTION

Accordingly, the invention is directed to a non-volatile semiconductor memory capable of high-speed data reading to resolve aforementioned problems in the conventional techniques.

The invention provides a non-volatile semiconductor memory including a memory array, a page buffer, and a data register. The memory array includes a plurality of memory cells. The page buffer stores data transmitted from pages selected according to address information in the memory array. The data register receives the data from the page buffer and serially outputs the received data according to a clock signal. The memory array includes at least a first memory plane and a second memory plane. Data of selected pages of the first memory plane and the second memory plane are simultaneously transmitted to the page buffer. A data reading method in the invention includes following steps. When data of a first page of the first memory plane is output from the data register, data of a second page of the second memory plane is transmitted from the page buffer to the data register. When the data of the second page of the second memory plane is output from the data register, data of a second page of the first memory plane is transmitted from the page buffer to the data register.

The invention further provides a non-volatile semiconductor memory including a memory array, a page buffer, and a data register. The memory array includes a plurality of memory cells. The page buffer stores data transmitted from pages selected according to address information in the memory array. The data register receives the data from the page buffer and serially outputs the received data according to a clock signal. The memory array includes at least a first memory plane and a second memory plane. Data of selected pages of the first memory plane and the second memory plane are simultaneously transmitted to the page buffer. The non-volatile semiconductor memory has a selection mechanism and a control mechanism. The selection mechanism selects pages of at least the first memory plane and the second memory plane of the memory array according to address information. The control mechanism controls data reading operations performed on the pages selected by the selection mechanism. When the control mechanism outputs data of a first page of the first memory plane from the data register, the control mechanism transmits data of a second page of the second memory plane from the page buffer to the data register. When the control mechanism outputs the data of the second page of the second memory plane from the data register, the control mechanism transmits data of a second page of the first memory plane from the page buffer to the data register.

According to the invention, when data of a first page of a first memory plane is output, data of a second page of a second memory plane is transmitted from a page buffer to a data register, and when the data of the second page of the second memory plane is output from the data register, data of a second page of the first memory plane is transmitted from the page buffer to the data register. Thereby, data of the first page and the second page can be continuously and quickly read. Moreover, data can be continuously transmitted from the memory array to the page buffer by storing address information for selecting discontinuous pages in advance.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram illustrating the structure of a flash memory according to an embodiment of the invention.

FIG. 2A is a diagram illustrating that pages in the same memory block of a flash memory are read in a burst mode according to an embodiment of the invention.

FIG. 2B is a diagram illustrating a mode that pages in the same memory block of a flash memory are randomly read according to an embodiment of the invention.

FIG. 3A is a diagram illustrating that pages between blocks in a flash memory are read in a burst mode according to an embodiment of the invention.

FIG. 3B is a diagram illustrating that pages in different memory blocks of a flash memory are randomly read according to an embodiment of the invention.

FIG. 4 is a flowchart of a first data reading method of a flash memory according to an embodiment of the invention.

FIG. 5 is a flowchart of a second data reading method of a flash memory according to an embodiment of the invention.

FIG. 6 is a flowchart illustrating a two-plane cache read operation according to an embodiment of the invention.

FIG. 7 is a timing diagram of a two-plane cache read operation according to an embodiment of the invention.

FIG. 8 is a diagram illustrating an example of page burst read within a memory block according to a first embodiment of the invention.

FIG. 9 is a diagram illustrating an example of page random read within a memory block according to the first embodiment of the invention.

FIG. 10 is a diagram illustrating an example of page burst read between memory blocks according to the first embodiment of the invention.

FIG. 11 is a diagram illustrating an example of page burst read between memory blocks according to a second embodiment of the invention.

FIG. 12 is a diagram illustrating the circuit structure of a memory array of a flash memory.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

Embodiments of the invention will be described in detail with reference to accompanying drawings. A NAND flash memory having a plurality of memory planes will be explained according to an exemplary embodiment of the invention. The number of the memory planes may be two or more. Same as memory banks, when a row in a memory array is selected, the corresponding pages of all the memory planes are selected at the same time.

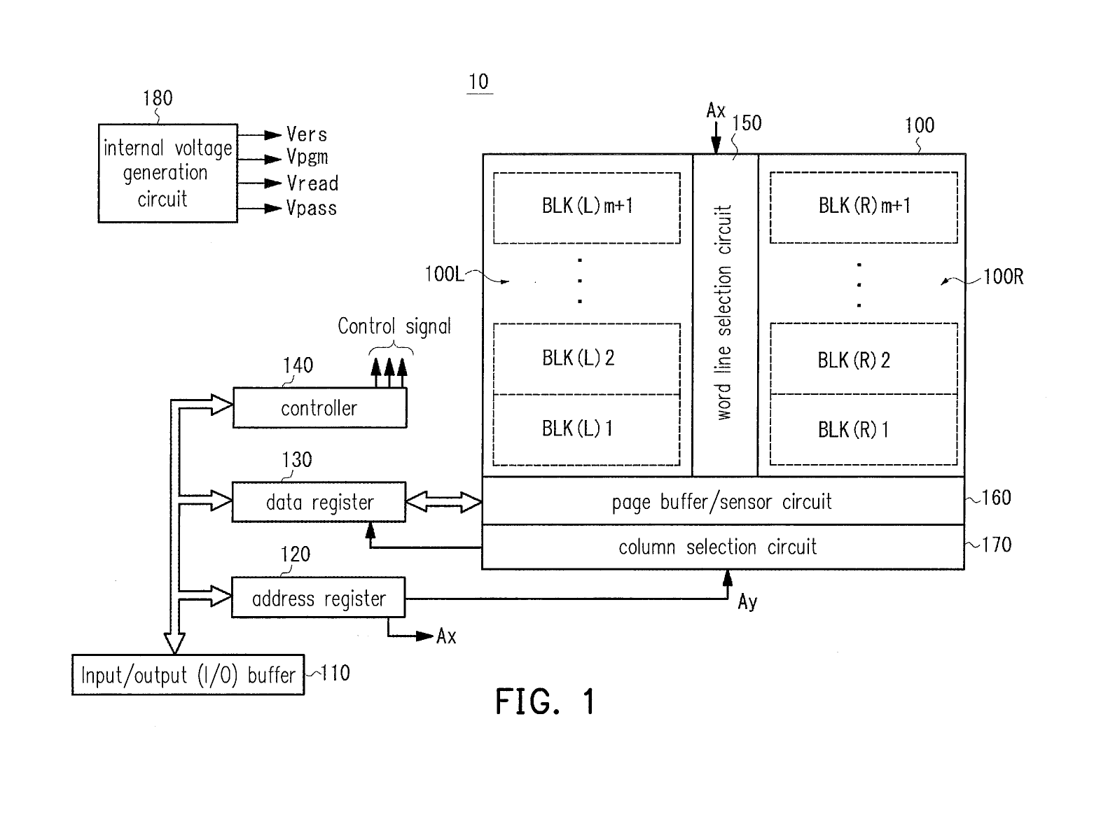

FIG. 1 is a block diagram illustrating the schematic layout structure of a NAND flash memory according to an embodiment of the invention. Referring to FIG. 1, the semiconductor memory 10 includes a memory array 100, an input/output (I/O) buffer 110, an address register 120, a data register 130, a controller 140, a word line selection circuit 150, a page buffer/sensor circuit 160, a column selection circuit 170, and an internal voltage generation circuit 180. The memory array 100 has a plurality of memory cells arranged along the row and column directions as an array. The I/O buffer 110 is connected to external I/O terminals and is configured to store data to be input and/or output. The address register 120 is configured to receive address information from the I/O buffer 110. The data register 130 is configured to store the data to be input and output. The controller 140 is configured to receive command data from the I/O buffer 110 and control each component according to the command data. The word line selection circuit 150 is configured to decode a row address information Ax from the address register 120 and select a memory block and a word line according to the decoded result. The page buffer/sensor circuit 160 is configured to store data to be read from or written into pages selected by the word line selection circuit 150. The column selection circuit 170 is configured to decode a column address information Ay from the address register 120 and select a column according to the decoded result. The internal voltage generation circuit 180 is configured to generate voltages required for reading, programming, and erasing data.

The memory array 100 is partitioned into two memory planes (memory banks) 100L and 100R. The word line selection circuit 150 is disposed between the memory planes 100L and 100R. The memory planes 100L and 100R have substantially the same structure. Namely, the memory plane 100L has m memory blocks BLK (L)1, BLK (L)2, . . . , and BLK (L)m in the column direction, the memory plane 100R has m memory blocks BLK (R)1, BLK (R)2, . . . , and BLK (R)m in the column direction, and each of the memory blocks has a plurality of pages.

The page buffer 160 is connected to bit lines of the memory planes 100L and 100R and has a storage capacity for temporarily storing two pages of data of the memory planes 100L and 100R. Additionally, in the present embodiment, to perform cache read operations, the data register 130 has a capacity for storing two pages of data of the memory planes 100L and 100R, and data from the page buffer 160 is input in parallel and serially output according to a clock signal. During the burst read for page data, the data register 130 continuously outputs two pages of data from the first columns (bits) to the last columns (bits) of the pages. Moreover, in reading modes other than the burst mode, data of a column selected by the column selection circuit 170 is output.

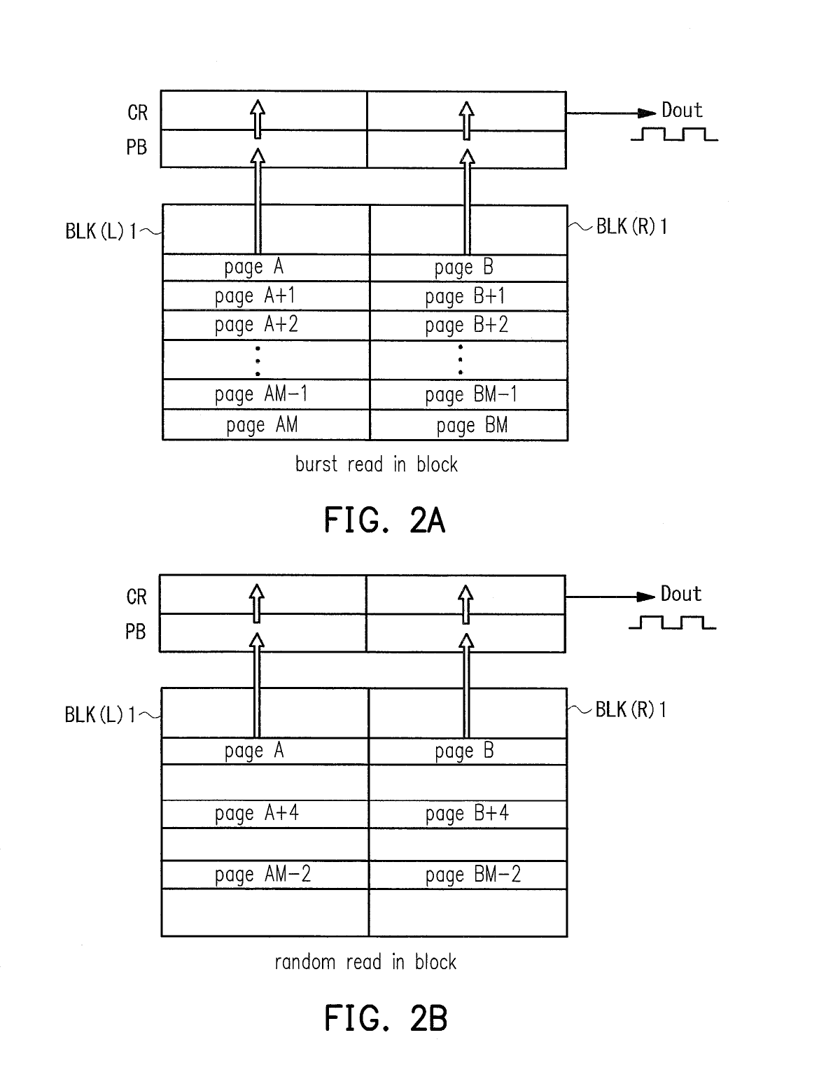

The cache read for two memory planes of the semiconductor memory 10 in the present embodiment will be described. FIG. 2A is a schematic diagram illustrating the operation of the page burst read in the memory block are read according to the present embodiment. In the memory array 100, a page buffer PB is connected with a cache register CR. The page buffer PB is configured to store data transmitted from selected pages in the two memory planes, and the cache register CR is configured to store data transmitted from the page buffer PB. The page buffer PB may be disposed in the page buffer/sensor circuit 160 illustrated in FIG. 1, and the cache register CR may be disposed in the data register 130 illustrated in FIG. 1.

The burst read within a memory block illustrated in FIG. 2A is to read data from a page at an assigned address in a memory block to the last page of the memory block. When a command for performing a burst read within a memory block is input, the controller 140 interprets the command and controls the burst read performed within the memory block. Then, address information for assigning the starting page to be read in the specified memory block is input. The word line selection circuit 150 selects the memory blocks BLK (L)1 and BLK (R)1 of the memory planes 100L and 1008 according to an input row address Ax and selects pages in these memory blocks. Referring to FIG. 2A, a page A and a page B are selected.

Next, data of the selected pages A and B is transmitted to the page buffer PB through the bit lines. The page buffer PB stores two pages of data of the memory planes 100L and 100R. Namely, the bit number of the page buffer PB is corresponding to the number of bit lines of the memory planes 100L and 100R in the column direction.

In the next sequence, data in the page buffer PB is transmitted to the cache register CR in parallel. When or before the data is output from the cache register CR, data of the next pages, i.e., the pages A+1 and B+1, is transmitted to the page buffer PB. In the two-plane cache read of the present embodiment, in the mode of continuously outputting two pages of data, before data of a page of one of the two memory planes is read from the cache register CR, data of a page of the other memory plane is transmitted from the memory array to the page buffer PB. After that, regardless of whether reading the data of one of the memory plane from the cache register CR is started or not, the page data of the other memory plane in the page buffer PB is always transmitted to the cache register CR, ready for next data output. Same as the page buffer PB, the cache register CR can store two pages of data and serially output the stored data in synchronization with a clock signal. The cache register CR can output data from a column selected by the column selection circuit 170 according to a column address information Ay. However, in the burst mode, data of pages from the starting column to the last column is continuously and serially output. The cache register CR can output the data in synchronization with one or both of the rising edge and the falling edge of a clock signal.

Thereby, when the cache register CR outputs data, data of the next page is transmitted to the page buffer PB, so as to perform a burst read operation on continuous pages until the last pages (i.e., a page AM and a page BM) of the memory blocks.

FIG. 2B is a schematic diagram illustrating an operation of random read in the memory block according to an embodiment of the invention. In this reading mode, discontinuous pages within a memory block are continuously read. When a command for random reading mode is input, the controller 140 starts the reading control. Then, address information for selecting the discontinuous pages is input externally. In FIG. 2B, row addresses for selecting pages A and B, row addresses for selecting pages A+4 and B+4, and row addresses for selecting pages AM−2 and BM−2 are input as the address information. The cache read operation is performed in the same way as that described above. Namely, when data of the pages A and B is serially output from the cache register CR, data of the next pages (i.e., the pages A+4 and B+4) has been stored in the page buffer PB, and eventually, data of the pages AM−2 and BM−2 is output from the cache register CR.

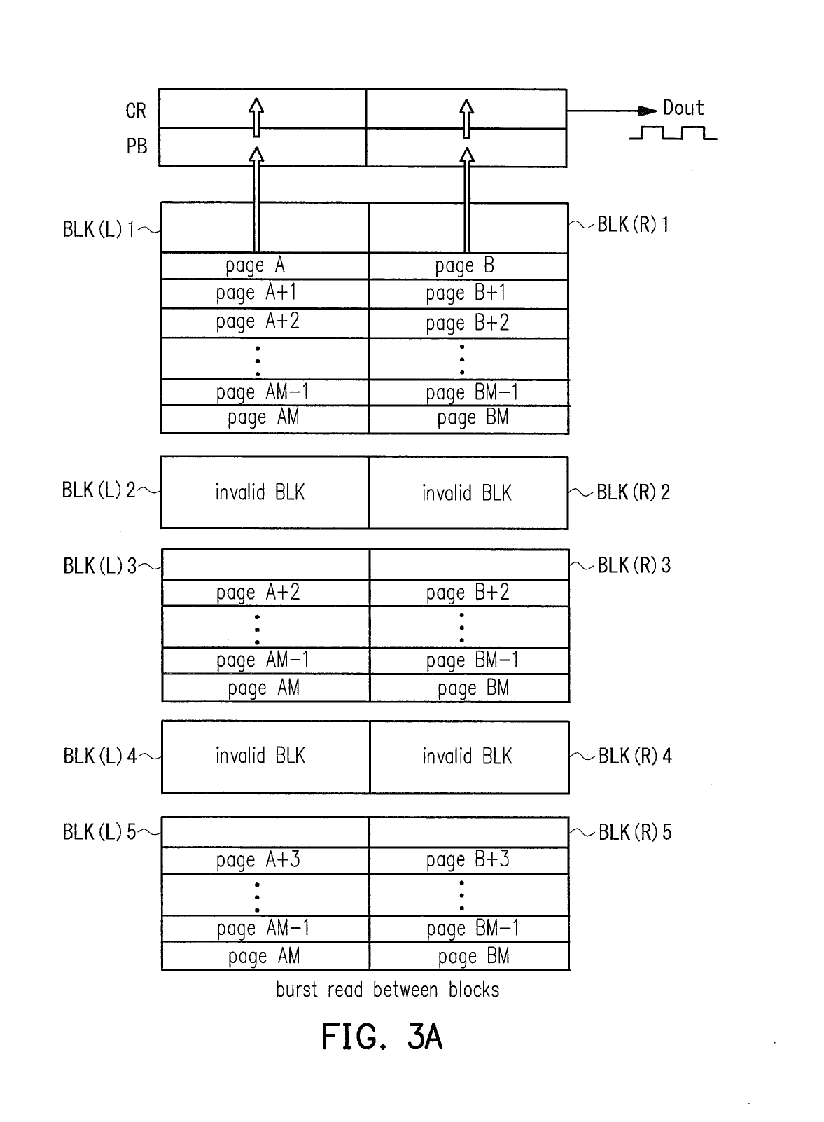

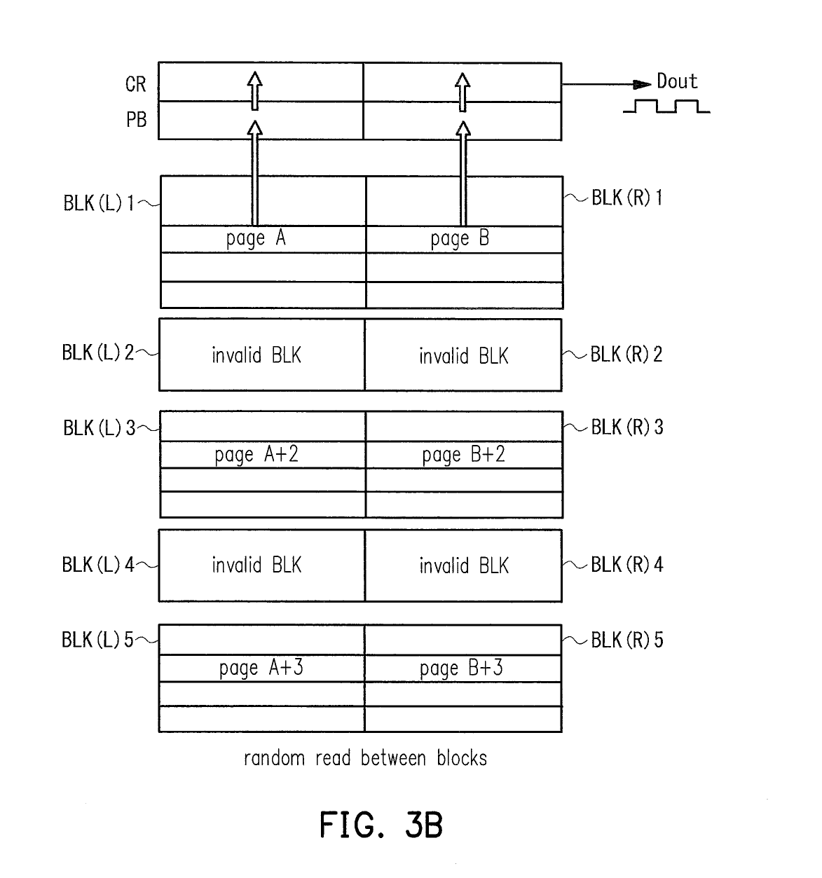

FIG. 3A is a schematic diagram illustrating an operation of burst read between memory blocks according to an embodiment of the invention. In this reading mode, continuous pages in different memory blocks are read. When a command for the burst read mode is input, address information for selecting the first pages of different memory blocks is input externally. In FIG. 3A, row addresses for selecting pages A and B in memory blocks BLK (L)1 and BLK (R)1, row addresses for selecting pages A+2 and B+2 in memory blocks BLK (L)3 and BLK (R)3, and row addresses for selecting pages A+3 and B+3 in memory blocks BLK (L)5 and BLK (R)5 are input as the address information. First, data from pages A and B to the last pages AM and BM in the memory blocks BLK (L)1 and BLK (R)1 are continuously read. Then, data of pages A+2 and page B+2 to the last pages AM and BM in the memory blocks BLK (L)3 and BLK (R)3 are continuously read. Next, data from pages A+3 and B+3 to the last pages AM and BM in the memory blocks BLK (L)5 and BLK (R)5 are continuously read.

FIG. 3B is a diagram illustrating an operation of random read between memory blocks according to an embodiment of the invention. In this reading mode, random pages in different memory blocks are continuously read. When a command for the reading mode is input, address information for selecting random pages in different memory blocks is input externally. In FIG. 3B, same as that in FIG. 3A, row addresses for selecting pages A and B in the memory blocks BLK (L)1 and BLK (R)1, row addresses for selecting pages A+2 and B+2 in the memory blocks BLK (L)3 and BLK (R)3, and row addresses for selecting pages A+3 and B+3 in the memory blocks BLK (L)5 and BLK (R)5 are input. When data of pages A and B in the memory blocks BLK (L)1 and BLK (R)1 is output from the cache register CR, data of pages A+2 and B+2 in the memory blocks BLK (L)3 and BLK (R)3 is stored in the page buffer PB. When data of pages A+2 and B+2 in the memory blocks BLK (L)3 and BLK (R)3 is output from the cache register CR, data of pages A+3 and B+3 in the memory blocks BLK (L)5 and BLK (R)5 is stored in the page buffer PB. Besides, random pages in different memory blocks are burst read.

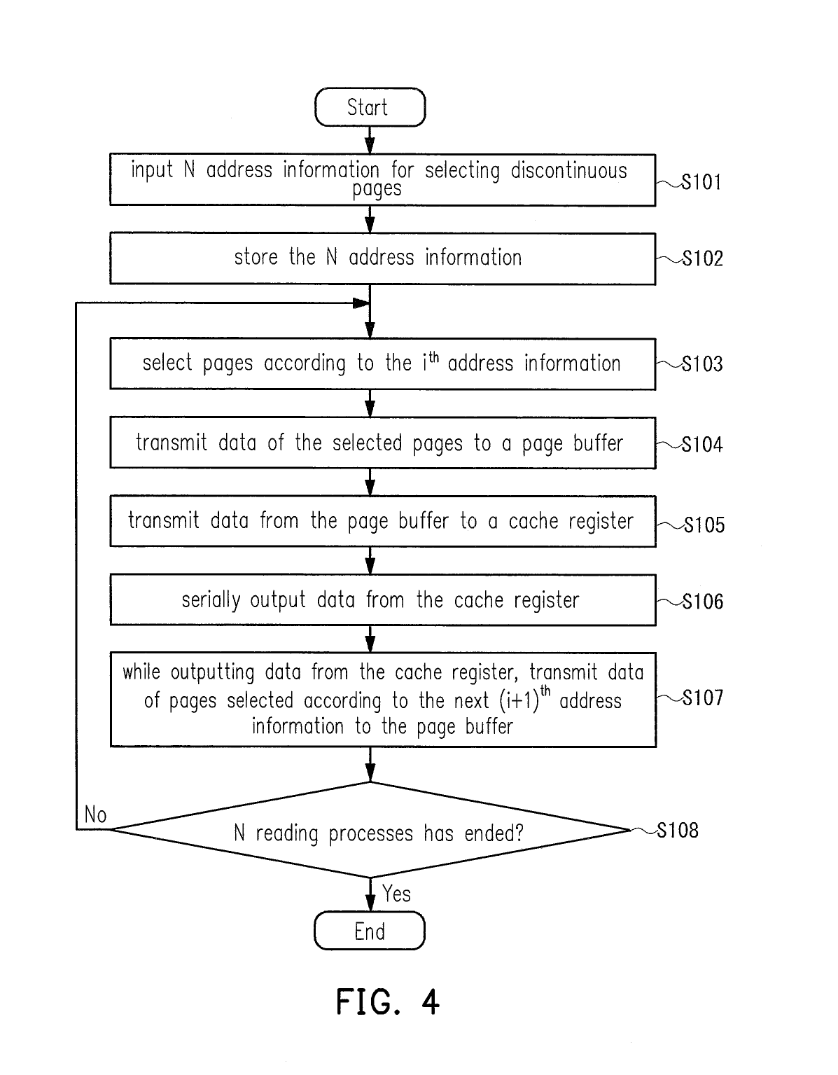

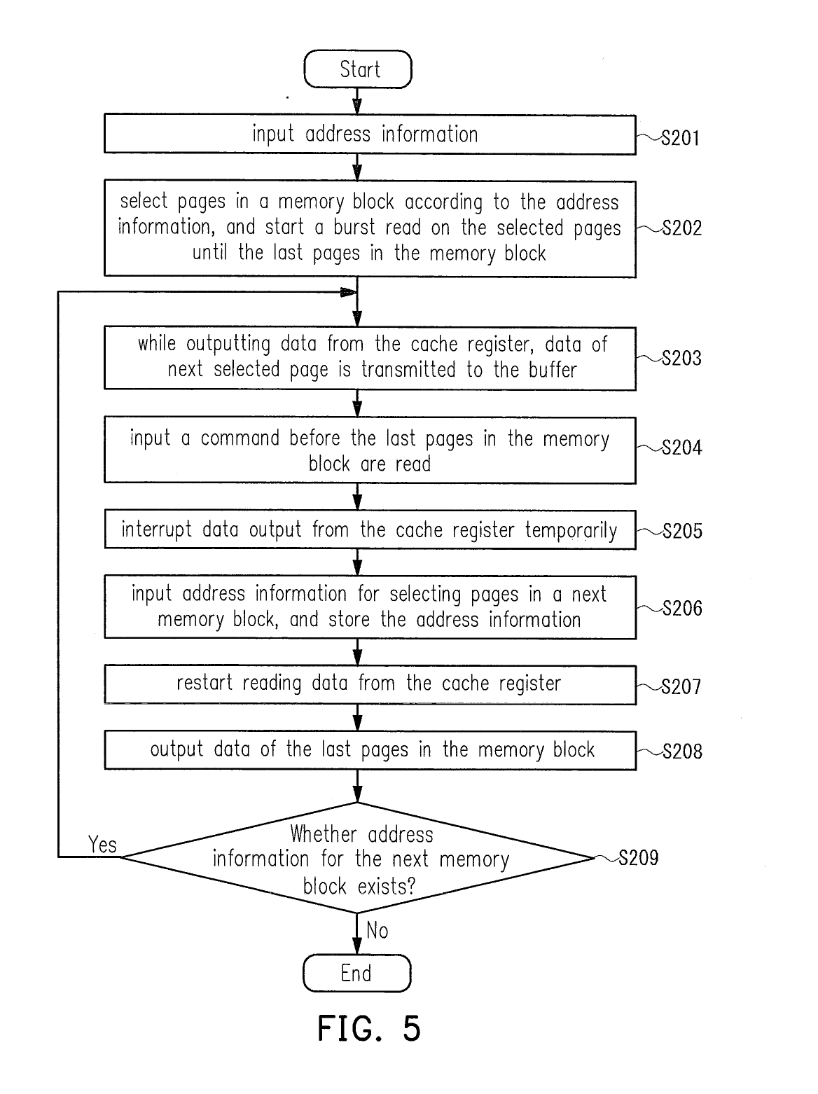

FIG. 4 is a flowchart of a first data reading method according to an embodiment of the invention. In the first data reading method, address information is input and stored in advance. Herein the address information is for selecting discontinuous pages required for the random read between memory blocks illustrated in FIG. 2B, the burst read between memory blocks illustrated in FIG. 3A, and the random read between memory blocks illustrated in FIG. 3B. First, a command regarding the first data reading method is input to the semiconductor memory 10 from an external controller. The controller 140 controls various components for executing the first data reading method according to the command. Then, N address information (N is a natural number greater than or equal to 2) for selecting discontinuous pages is input to the semiconductor memory 10 (step S101). The inputted address information is stored by being stacked in the address register 120 (step S102).

Next, the word line selection circuit 150 selects pages in the memory array according to the i^{th} (i is a natural number greater than or equal to 1) address information stored in the address register 120 (step S103). The word line selection circuit 150 selects two pages of the memory plane 100L and 100R at the same time. After that, data of the selected pages is transmitted to the page buffer PB (step S104). Thereafter, the data in the page buffer PB is transmitted to the cache register CR (step S105) and serially output from the cache register CR in synchronization with a clock signal. Before end of the data being output from the cache register CR, data of pages selected according to the (i+1)^{th} address information is transmitted to the page buffer PB (step S107). In this way, data of pages selected by using N address information is burst read.

In the first data reading method, because the N address information for selecting discontinuous pages is input in advance, there is no need to input the address information every time when the discontinuous pages are read. Thus, the busy period for transmitting data of pages selected in response to the input of address information from the memory array to the page buffer is only produced when the initial pages are selected. Thereby, high speed data reading can be realized.

Ideally, the time t1 for outputting two pages of data from the cache register is slightly longer than the time t2 for transmitting data from the memory array to the page buffer. Thus, when data is output from the cache register, data transmission from the memory array to the page buffer can be carried out in the background.

FIG. 5 is a flowchart of a second data reading method according to an embodiment of the invention. In the second data reading method, the address information for selecting discontinuous pages required by the burst read between memory blocks illustrated in FIG. 3A is input at the most appropriate timing. At the beginning, a command regarding the second data reading method is input externally. Then, the address information is input (step S201). Herein the address information is for selecting the first page to be read in a certain memory block. Under the control of the controller 140, the word line selection circuit 150 selects the page in the memory block according to the input address information and then performs the burst read on the selected pages until the last page in the memory block (step S202).

When data is output from the cache register CR, data of the next selected page is transmitted to the page buffer PB (step S203). Next, a command is input before data of the last page in the memory block is read from the cache register CR (step S204). After that, the controller 140 stops the clock signal in response to the command, so as to interrupt the output of data from the cache register CR temporarily (step S205). However, this temporal interruption for the reading is not compulsory and may be optional. Then, address information for selecting a page in a next memory block is input from an external controller to the semiconductor memory 10, and the address information is stored in the address register 120 (step S206). After the controller 140 inputs the address information, restart reading data from the cache register CR (step S207). Besides, before the data of the last page in the memory block is output, the controller 140 checks whether the address information corresponding to a next memory block is stored in the address register 120 (step S209). If such address information is stored, data of the page selected according to this address information is transmitted to the page buffer PB. This data transmission is carried out before data of the last page in the cache register CR is read. On the other hand, the data reading procedure is terminated if no address information corresponding to a next memory block is stored.

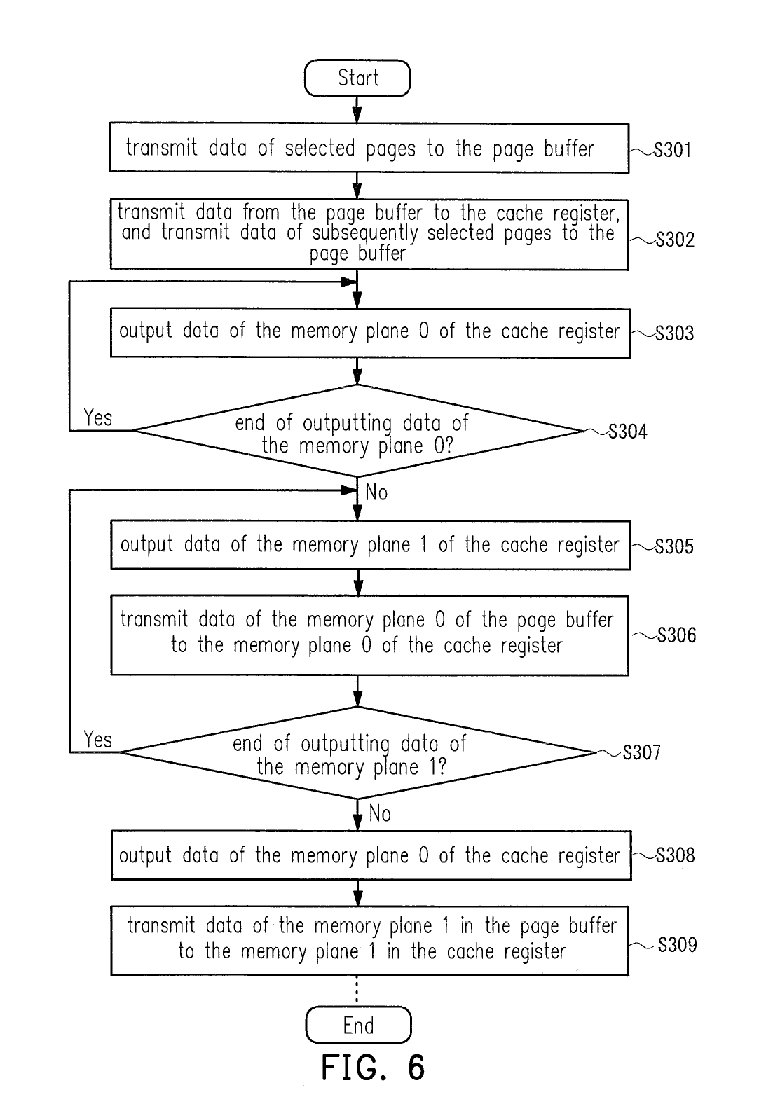

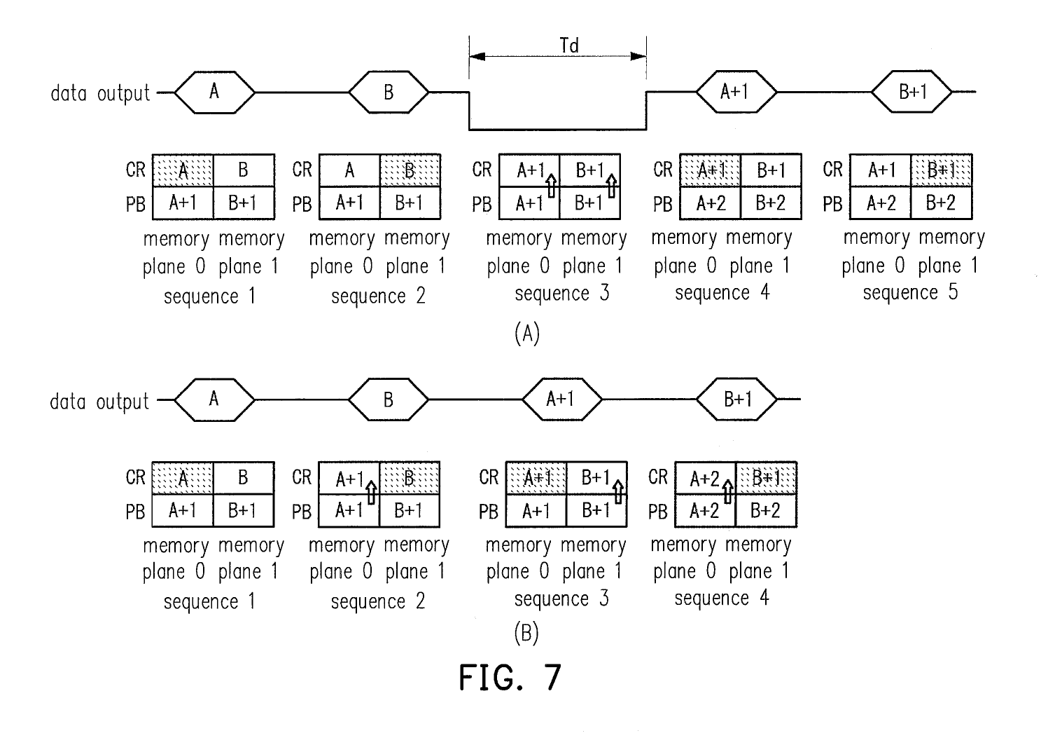

Below, a cache read operation performed on two memory planes will be explained with reference to an embodiment of the invention. The cache read operation in the present embodiment is adapted to the burst read in the memory block illustrated in FIG. 2A, the random read in the memory block illustrated in FIG. 2B, the burst read between memory blocks illustrated in FIG. 3A, and the random read between the memory blocks illustrated in FIG. 3B. Preferably, the controller 140 includes a control program and generates control signals for controlling various components according to external commands. FIG. 6 is a flowchart of the cache read operation, and FIGS. 7A and 7B are timing diagrams of the cache read operation.

First, data of selected pages in the memory array is transmitted to the page buffer PB (step S301). As shown in FIG. 1, the memory array has two memory planes. Thus, page data of the same row in the memory planes 100L and 100R is transmitted to the page buffer PB. If the memory array has four memory planes, page data of the four memory planes is transmitted to the page buffer. Additionally, thereinafter, in the cache register CR and the page buffer PB, the area storing data transmitted from the memory plane 100L is referred to as a memory plane 0, and the area storing data transmitted from the memory plane 100R is referred to as a memory plane 1.

Then, data in the page buffer PB is transmitted to the cache register CR, and data of the next selected pages is transmitted to the page buffer PB (step S302). In this status, the cache register CR stores the data of previously selected pages of the memory planes 0 and 1, and the page buffer PB stores the data of the next selected pages of the memory planes 0 and 1.

Next, data in the memory plane 0 is sequentially output from the cache register CR. The column selection circuit 170 sequentially and serially outputs data by starting from the starting address of the cache register CR (the data register 130) in synchronization with a clock signal. The column selection circuit 170 may include a counter which increments its value in response to aforementioned clock signal and select an address in the cache register CR according to the value of the counter, so as to allow the data to be sequentially output.

FIG. 7B illustrates a two-plane cache read operation according to the present embodiment. In the reading sequence 1 illustrated in FIG. 7B, data of page A of the memory plane 0 is output from the cache register CR. Herein the cache register CR stores the data of page A of the memory plane 0 and data of page B of the memory plane 1, and the page buffer PB stores data of the next page A+1 of the memory plane 0 and data of page B+1 of the memory plane 1.

The controller 140 determines whether all the data of the memory plane 0 is output from the cache register CR (step S304). The determined result is used for controlling the data transmission from the page buffer PB to the cache register CR. If reading the data of the memory plane 0 is ended, data of the memory plane 1 is output from the cache register CR (step S305). Data reading is continuous from the memory plane 0 to the memory plane 1 in the cache register CR. If the data output of the memory plane 0 is ended, i.e., if reading data of the memory plane 1 is started, data of pages of the memory plane 0 in the page buffer PB is transmitted to the cache register CR under the control of the controller 140 (step S306).

In the reading sequence 2 illustrated in FIG. 7B, during data of the page B of the memory plane 1 being output from the cache register CR, data of the next page A+1 of the memory plane 0 in the page buffer PB is transmitted to the cache register CR.

Next, the controller 140 determines whether all the data in the memory plane 1 is output from the cache register CR (step S304). This determined result is used for controlling the data transmission from the page buffer PB to the cache register CR. If reading the data in the memory plane 1 is ended, data of the memory plane 0 is output from the cache register CR (step S308). Data reading is continuous from the memory plane 1 to the memory plane 0 in the cache register CR. If the data output in the memory plane 1 is ended, i.e., if reading data in the memory plane 0 is started, data of pages of the memory plane 1 in the page buffer PB is transmitted to the cache register CR under the control of the controller 140 (step S309).

Similarly, when data of one of the memory planes is output from the cache register CR, data of the other memory plane is transmitted from the page buffer PB, so that data among plural pages can be continuously read from the cache register CR.

In the reading sequence 3 illustrated in FIG. 7B, during data of the page A+1 of the memory plane 0 being output from the cache register CR, data of the next page B+1 of the memory plane 1 in the page buffer PB is transmitted to the cache register CR. Additionally, in the reading sequence 4, before reading data of the page B+1 of the memory plane 1 from the cache register CR is ended, data of the next pages A+2 and B+2 is transmitted from the memory planes to the page buffer, and data of the page A+2 of the memory plane 0 in the page buffer PB is transmitted to the cache register CR.

On the other hand, a conventional data reading operation is illustrated in FIG. 7A. In the reading sequence 1, same as that illustrated in FIG. 7B, data of page A is output. In the reading sequence 2, data of page B of the memory plane 1 in the cache register CR is output. However, during this period, data of the next page A+1 in the page buffer PB is not transmitted to the cache register CR. In the next reading sequence 3, data of the next pages A+1 and B+1 of the memory planes 0 and 1 in the page buffer PB is transmitted to the cache register CR. During this data transmission period Td, no data is output from the cache register CR. In the reading sequence 4, data of page A+1 of the memory plane 0 is output from the cache register CR. In the reading sequence 5, data of page B+1 of the memory plane 1 is output from the cache register CR. Thereby, in the conventional technique, data of the next pages of the memory planes 0 and 1 is transmitted from the page buffer PB after all the data of the memory planes 0 and 1 in the cache register CR is output. Thus, when reading data among plural pages, a blank period Td is produced and accordingly the data reading is delayed.

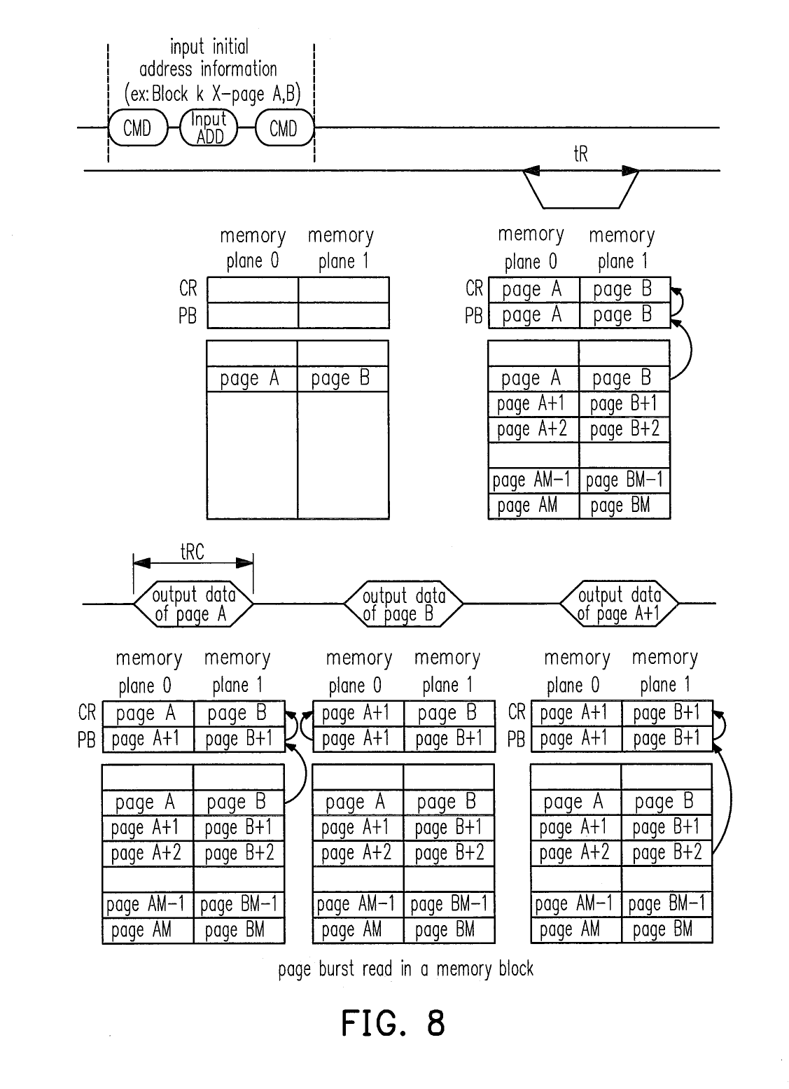

Next, specific reading operations in embodiments of the invention will be explained with reference to FIGS. 8-11. FIG. 8 illustrates an example of reading continuous pages within a memory block (FIG. 2A). First, a command is input from an external controller to the semiconductor memory 10. Then, address information for selecting initial pages in the memory blocks is input. In the present embodiment, address information for selecting pages A and B of the memory planes 0 and 1 is input. If inputting the address information is ended, a command is input again, and the semiconductor memory 10 performs a page burst read in response to the command. If the pages are selected according to the address information, data of the pages A and B is transmitted from the memory array 100 to the page buffer PB and the cache register CR. During this data transmission period tR, the semiconductor memory 10 outputs a busy signal to the external controller.

During the data reading period tRC, data of page A is output from the cache register CR, and then data of page B is output subsequently at which data of the next page A+1 is also transmitted to the cache register CR. Accordingly, the cache read is performed until the last pages AM and BM of the memory blocks. This reading method does not produce the blank period Td as shown in FIG. 7A therefore can read data more efficiently than the conventional technique.

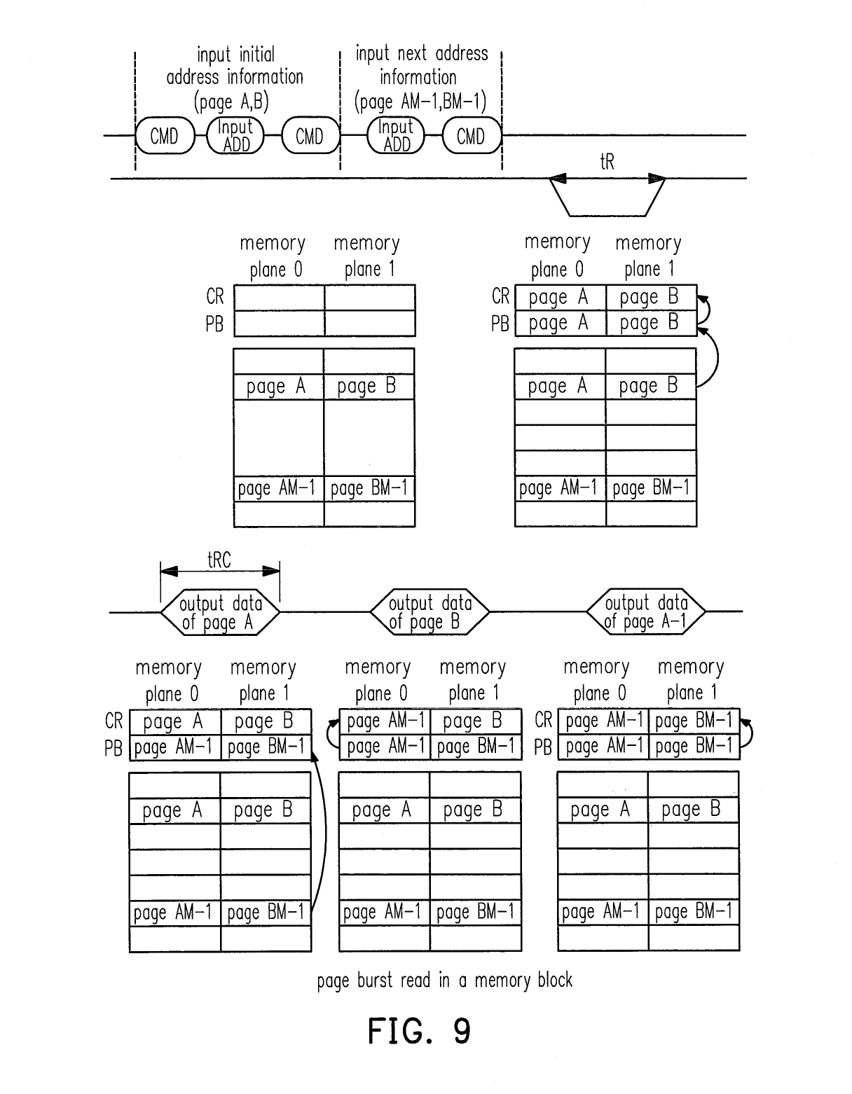

FIG. 9 illustrates an example of page random read within a memory block (FIG. 2B). This example will be explained with reference to the first data reading method illustrated in FIG. 4. First, a command is input from an external controller to the semiconductor memory 10. Then, address information for selecting the initial pages (i.e., the pages A and B) in the memory blocks is input, and the address information is stored in the address register 120. Next, a command is input, and address information for selecting the next pages (i.e., the pages AM−1 and BM−1) in the memory blocks is input and stored in the address register 120. If inputting the address information is ended, a command is input from the external controller to the semiconductor memory 10, and the semiconductor memory 10 performs the page random read in the memory blocks according to this command. In the first data reading method, because the address information is input in advance, there is no need to input the address information when discontinuous pages are read. Thus, the busy period for transmitting data of pages selected in response to the input of the address information from the memory array to the page buffer won't be produced. Namely, data of pages AM−1 and BM−1 is already transmitted to the page buffer when data of pages A and B is output, data of page AM−1 is transmitted from the page buffer PB to the cache register CR when data of page B is read, and data of pages AM−1 and BM−1 is burst read after data of pages A and B is read.

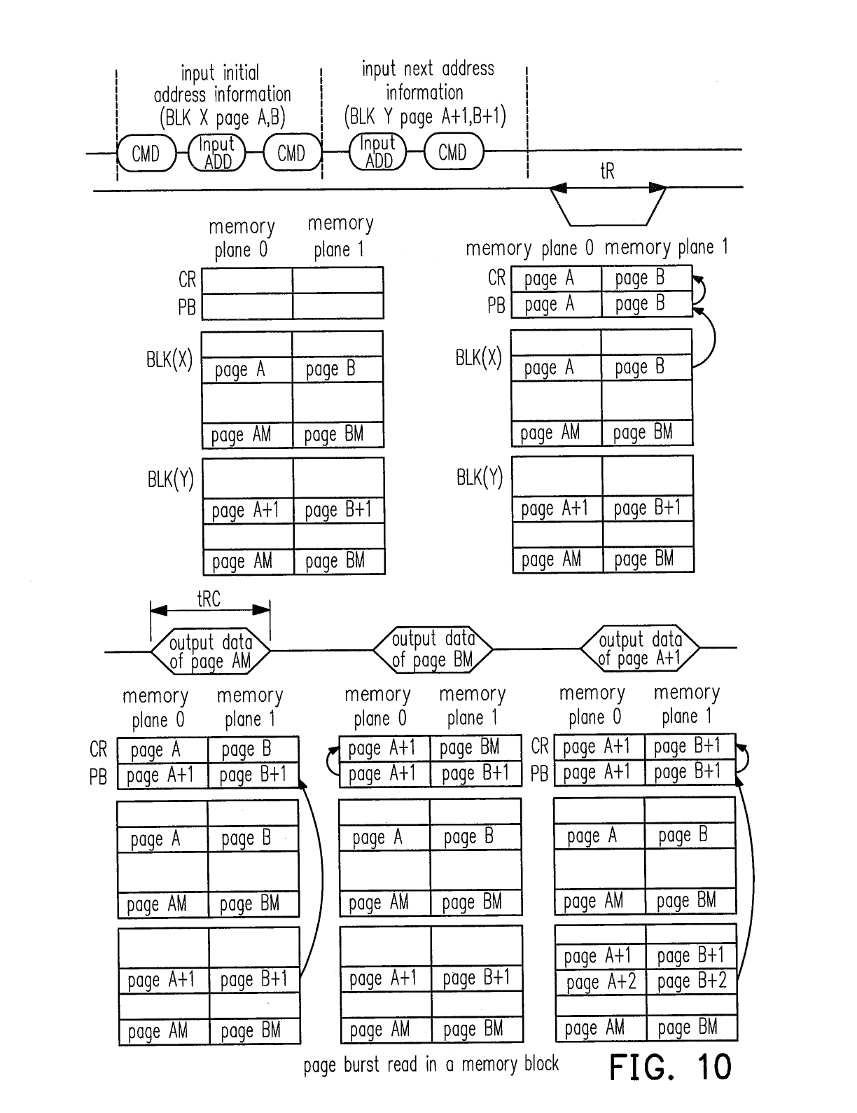

FIG. 10 illustrates an example of page burst read between memory blocks (FIG. 3A). Unlike that in the example illustrated in FIG. 9, in the present example, address information for selecting pages in different memory blocks is input in advance. In the present example, after a burst read is performed on pages A and B to pages AM and BM in the memory block BLK (X), a burst read is performed on pages A+1 and B+1 to pages AM and BM in the memory block BLK (Y). In addition, even though no example of page random read between memory blocks (as illustrated in FIG. 3B) is described herein, in such a case, the address information for selecting pages in different memory blocks may also be input in advance, so as to read data of these pages efficiently, as described in foregoing examples.

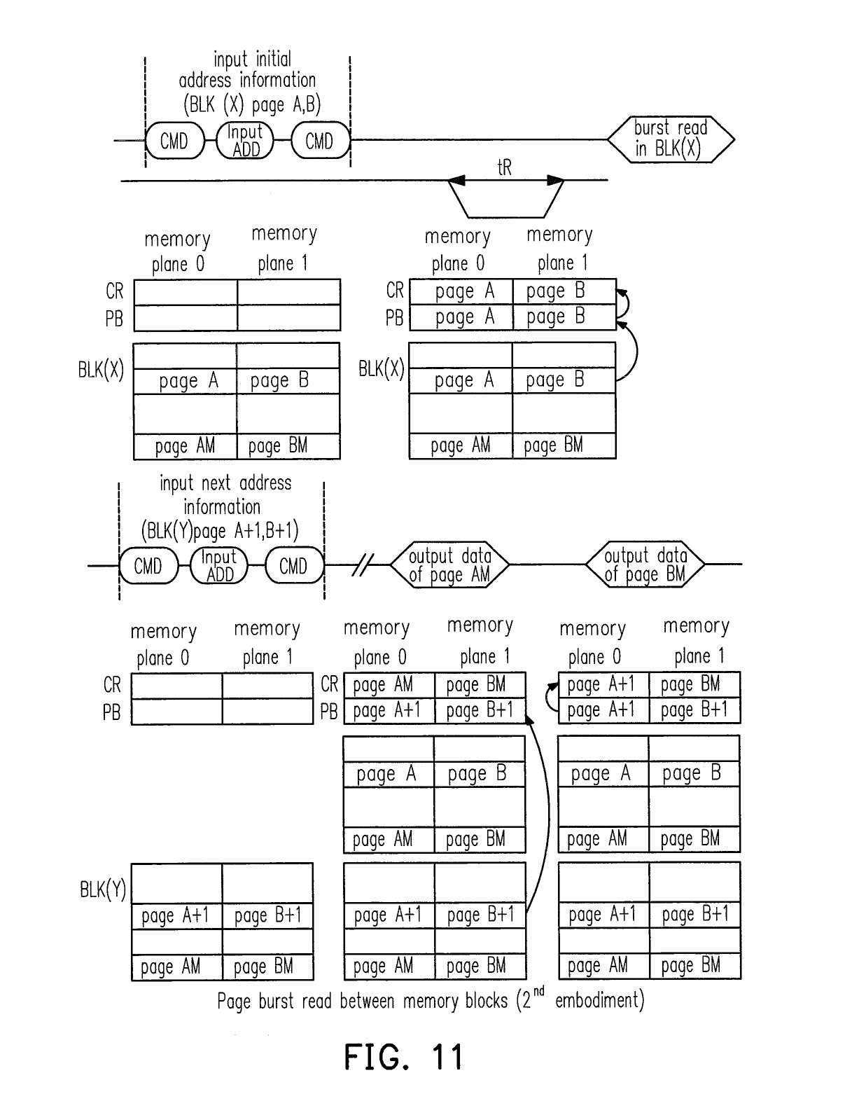

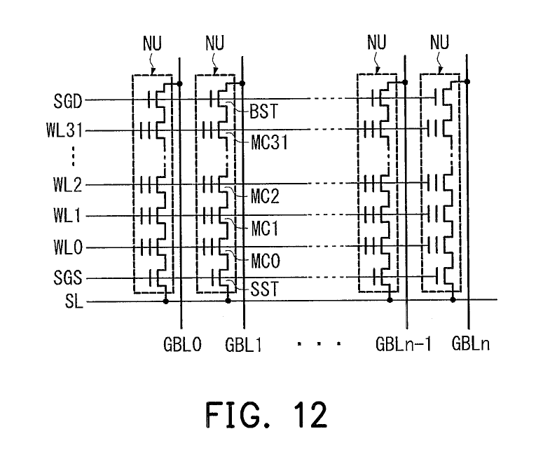

FIG. 11 illustrates an example of page burst read between memory blocks through the second data reading method illustrated in FIG. 5. First, after a command is input from an external controller, address information for selecting pages A and B in the memory block BLK (X) is input. Thereafter, if a command is input, the semiconductor memory 10 performs page burst read between memory blocks according to this command.

Before ending the burst read performed on the memory block BLK (X), a command is input from the external controller, and address information for selecting pages A+1 and B+1 in the next memory block BLK (Y) is input. Herein the controller 140 may also stop temporarily the data output from the cache register CR by stopping the clock signal. In this case, the address information is temporarily stored in the address register 120. Thereafter, if a command is input from the external controller, the controller 140 starts to output data from the cache register CR again by starting from the next data that has been stopped. Before data of the last pages AM and BM in the memory block BLK (X) is output, data of pages A+1 and B+1 in the next memory block BLK (Y) is transmitted to the page buffer PB. After that, when data of the last page BM is output, data of page A+1 is transmitted from the page buffer PB to the cache register CR. Accordingly, high speed of page burst read between memory blocks can be realized. Moreover, in order to accomplish continuous burst read, inputting commands for selecting pages in the next memory block BLK (Y) is inhibited during the period after the output of the last pages AM and BM is started.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A data reading method of a non-volatile semiconductor memory, wherein the non-volatile semiconductor memory comprises a memory array, a page buffer and a data register, the memory array comprises a plurality of memory cells, the page buffer stores data transmitted from pages selected according to address information in the memory array, and the data register receives the data from the page buffer and serially outputs the received data according to a clock signal, wherein the memory array comprises at least a first memory plane and a second memory plane, and data of selected pages of at least the first memory plane and the second memory plane is simultaneously transmitted to the page buffer, the data reading method comprising:
when data of a first page of the first memory plane is output from the data register, transmitting data of a second page of the second memory plane from the page buffer to the data register; and
when the data of the second page of the second memory plane is output from the data register, transmitting data of a second page of the first memory plane from the page buffer to the data register.

2. The data reading method according to claim 1 further comprising:
inputting at least two address information capable of selecting at least two discontinuous pages;
storing the at least two address information;
selecting the first pages of the first memory plane and the second memory plane of the memory array according to a first address information in the at least two address information;
transmitting the data of the first page to the page buffer; and
when the data of the first page is read from the data register, transmitting the data of the second pages of the first memory plane and the second memory plane selected according to a second address information in the at least two address information from the memory array to the page buffer.

3. The data reading method according to claim 1, wherein the first address information is for selecting first pages in a first memory block of the first memory plane and the second memory plane of the memory array, and the second address information is for selecting second pages in a second memory block of the first memory plane and the second memory plane of the memory array.

4. The data reading method according to claim 2, wherein the first address information is for selecting the first pages in the first memory block of the first memory plane and the second memory plane of the memory array, and the second address information is for selecting the second pages in the first memory block.

5. The data reading method according to claim 1 further comprising:
inputting at least two address information capable of selecting pages in different memory blocks of the first memory plane and the second memory plane;
storing the at least two address information;
selecting first pages in a first memory block of the first memory plane and the second memory plane of the memory array according to a first address information in the at least two address information;
sequentially transmitting data of the first pages to last pages in the first memory block of the first memory plane and the second memory plane to the page buffer; and
when the data of the last pages in the first memory block is read from the data register, transmitting data of second pages in a second memory block of the first memory plane and the second memory plane selected according to a second address information in the at least address information from the memory array to the page buffer.

6. The data reading method according to claim 1 further comprising:
inputting a first address information capable of selecting first pages of the first memory plane and the second memory plane;
selecting first pages in a first memory block of the first memory plane and the second memory plane according to the first address information;
before reading last pages in the first memory block, inputting a second address information capable of selecting second pages in a second memory block of the first memory plane and the second memory plane; and
when data of the last pages in the first memory block is read from the data register, transmitting data of the second pages in the second memory block of the first memory plane and the second memory plane selected according to the second address information from the memory array to the page buffer.

7. The data reading method according to claim 6, wherein a burst read performed on the data register is interrupted when a command for inputting the second address information is input, and the data register restarts the burst read after the second address information is input.

8. The data reading method according to claim 1, wherein the data register outputs data in synchronization with at least one of a rising edge and a falling edge of a clock signal having a specific frequency, and a time t1 for outputting data of pages of the first memory plane and the second memory plane from the data register is longer than a time t2 for transmitting data from the memory array to the page buffer.

9. A non-volatile semiconductor memory, comprising a memory array, a page buffer, and a data register, wherein the memory array comprises a plurality of memory cells, the page buffer stores data transmitted from selected pages according to address information in the memory array, and the data register receives the data from the page buffer and serially outputs the received data according to a clock signal, wherein the memory array comprises at least a first memory plane and a second memory plane, and data of selected pages of at least the first memory plane and the second memory plane is simultaneously transmitted to the page buffer, the non-volatile semiconductor memory comprising:
a selection mechanism, selecting pages of at least the first memory plane and the second memory plane of the memory array according to an address information; and
a control mechanism, controlling a data reading performed on the pages selected by the selection mechanism,
wherein when the control mechanism outputs data of a first page of the first memory plane from the data register, the control mechanism transmits data of a second page of the second memory plane from the page buffer to the data register, and when the control mechanism outputs the data of the second page of the second memory plane from the data register, the control mechanism transmits data of a second page of the first memory plane from the page buffer to the data register.

10. The non-volatile semiconductor memory according to claim 9 further comprising:
a storage mechanism, storing at least two address information capable of selecting at least two discontinuous pages when the at least two address information is input,
wherein when the control mechanism continuously outputs data of the first pages of the first memory plane and the second memory plane selected according to a first address information in the at least two address information from the data register, the control mechanism transmits data of the second pages of the first memory plane and the second memory plane selected according to a second address information in the at least two address information from the memory array to the page buffer.

11. The non-volatile semiconductor memory according to claim 9, wherein
the first address information is for selecting first pages in a first memory block of the first memory plane and the second memory plane of the memory array, and the second address information is for selecting second pages in a second memory block of the first memory plane and the second memory plane of the memory array.

12. The non-volatile semiconductor memory according to claim 10, wherein
the control mechanism selects the first pages in the first memory block of the first memory plane and the second memory plane according to the first address information in the at least two address information, performs a burst read operation on data of the first pages to last pages in the first memory block, and when the control mechanism continuously outputs the data of the last pages in the first memory block from the data register, the control mechanism transmits data of second pages in a second memory block of the first memory plane and the second memory plane selected according to the second address information in the at least two address information from the memory array to the page buffer.
